(19) United States
(12) Patent Application Publication
(10) Pub. No.: US 2004/0125979 A1
(43) Pub. Date: Jul. 1, 2004

(54) Earphone for a cellular phone

(76) Inventors: Josef Elidan, Jerusalem (IL); Michael Mager, Jerusalem (IL)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/344,068

(22) PCT Filed: Aug. 7, 2001
(86) PCT No.: PCT/IL01/00726

(51) Int. Cl. H04R 25/00

(52) U.S. Cl. 381/382; 381/380; 455/575.2

(57) ABSTRACT

An earphone for use with portable communication devices (PCDs), particularly cellular phones, where the electro-magnetic (EM) radiation of the device is distanced from the head of the user, while acoustic waves are collected and brought through an acoustic tube to the ear of the user. The earphone may employ a coupler where the coupler contains a microphone and speaker acoustically insulated from each other. The coupler is positioned distant from both the ear of the user and the PCD. The coupler delivers acoustic waves to an acoustic tube for transmittal to the ear.

### FIELD OF THE INVENTION

The present invention relates to an earphone for use with portable communication devices, particularly with cellular phones.

### BACKGROUND OF THE INVENTION

Cellular phones are known to emit electromagnetic (EM) radiation that is thought to be potentially harmful to biological tissues, particularly to the brain. In order to reduce this risk, various approaches have been suggested.

One approach uses radiation deflection shields (for example AegisGuard™) attached to a phone positioned near the ear and head of the user. Another approach tracks the cellular phone's output power, emitting a warning signal when the maximum permissible power limit is reached. Yet another proposed approach uses an electromagnetically charged solution, such as that utilized by the Tecno AO Oscillator. The solution emits low intensity, oscillating alpha waves in an extremely low range of frequencies (between 7.5-13.5 Hertz) and its compensating electromagnetic field counters the potentially harmful waves emitted by cellular phones. Another approach is that used by Rayaway chips, attachable to a cell phone and composed of a quartz crystal matrix which alters the carrier frequency of the radiation produced by the phone. Yet another proposed solution requires the attachment of special materials to a phone, such as Zeropa® ceramic materials, which absorb the electromagnetic radiation emitted by the phones.

Perhaps the most common and simplest approach is using common electrical earphones to increase the distance between the cellular phone and the brain when a transmission is received or sent. The phone itself can be hand held or attached to the user with a belt. However, it has been shown that a regular earphone may act as an antenna and actually concentrate the electromagnetic radiation in the region of the ear with possible insidious consequences to brain and other tissues. In order to render safe the use of earphones, elimination of the harmful effects resulting from their ability to concentrate electromagnetic radiation appears necessary.

### Definitions

The following terms will be used herein with the following meanings, except where noted otherwise.

Earphone—a device that transmits or converts and transmits electrical energy into sound waves and is worn over or inserted into the ear.

Earpiece—the part of a portable communication device, including a cellular phone, that is held next to the ear.

Ear mounting portion—the part of the present invention that is inserted into the ear canal or attached proximally to the external ear of a user.

Portable communication device—any device carried, worn or stored by an individual to receive or communicate messages. These include, but are not limited to the following types of devices: cellular phones, mobile phones, beepers, portable pagers and hand-held radios.

### SUMMARY OF THE PRESENT INVENTION

The present invention provides an apparatus for safely conveying transmissions received and sent by portable communication devices (PCDs), particularly cellular phones. The present inventors have realized that an apparatus which eliminates the use of electromagnetic (EM) radiation generated by elements in PCDs by transmitting acoustic waves over distances directly to the ear of the user makes PCDs, particularly cellular phones, safer.

It is an object of the present invention to provide a device for safely conveying cellular phone transmissions from the phone to the user, eliminating the harmful effects of EM radiation to delicate biological tissue, particularly brain tissue.

It is a further object of the present invention to provide a safe earphone for use with cellular phones, while retaining the advantages of distancing the cellular phone from the user.

It is yet another object of the present invention to provide a cheap, compact solution for reducing the electromagnetic radiation produced by cellular phones which reach a user.

It is a further object of the invention to provide an earphone which can replace conventional hands-free car speakers and other such devices.

Finally, it is another object of the present invention to provide a small compact device for coupling electrical signals with acoustic waves.

There is thus provided in accordance with the present invention an earphone for use with a portable communication device having an apparatus for receiving electrical signal energy corresponding to voice signals. The device also contains a speaker for providing to a user in response to the electrical signal energy audible, acoustic energy corresponding to the voice signals. The device also includes an audio socket for accessing the electrical signal energy. The earphone includes a collector portion arranged for connection to the portable communication device so as to receive energy corresponding to the voice signals. It also includes an acoustic energy delivery portion configured for fastening to the ear of a user and for delivering to the ear of the user acoustic energy corresponding to the voice signals. Finally, the earphone includes an acoustic tube for receiving energy output from the collector portion and for providing to the delivery portion acoustic energy for delivery to the ear of the user.

In another embodiment according to the present invention, the collector portion includes an acoustic collector-arranged for fastening to the speaker of the portable communications device. The acoustic collector operates by collecting audible acoustic energy from the speaker and focusing it along the acoustic tube for delivery to the ear of a user via the acoustic energy delivery portion.

In a further embodiment of the present invention, the collector portion includes an audio plug arranged for coupling with the audio socket of the portable communications device. The earphone also includes an acoustic energy transformer as well as an electrical signal conductor for conducting electrical signal energy from the audio plug to the acoustic energy transformer. The acoustic energy transformer, transforms the electrical signal energy into audible acoustic energy, and focuses it along the acoustic tube for delivery to the ear of a user via the acoustic energy delivery portion.

In yet another embodiment of the invention, the audio plug, the signal conductor, and the acoustic energy transformer are formed as a unitary plug element, configured for coupling with the audio socket of the portable communications device.

Additionally, in accordance with an embodiment of the present invention, the speaker of the device is an external speaker and the collector portion of the earphone is attached to the external speaker. The collector portion of the earphone can be attached to the external speaker by one or more of the following means of attachment: a mechanical element, a magnetic element, an adhesive material, and a vacuum.

In an alternative embodiment of the present invention, the speaker of the device is an internal speaker and the collector portion of the earphone is attached to the internal speaker. The collector portion of the earphone can be attached to the internal speaker by one or more of the following means of attachment: a mechanical element, a magnetic element, an adhesive material, and a vacuum.

In a further embodiment of the present invention, the acoustic delivery portion is configured for insertion into the ear canal or for proximate attachment to the external ear of an user.

Additionally, in accordance with a preferred embodiment, the acoustic tube is a bifurcated acoustic tube having two acoustic energy delivery portions for providing acoustic waves to both ears of a user simultaneously.

In a further embodiment of the invention the earphone contains an additional speaker for attaching to the collector portion of the earphone.

In yet another embodiment of the present invention, the earphone described above further includes a microphone, the microphone receiving acoustic signals from a user, converting them to electrical signals and delivering them to the portable communication device. The conveyance of the electrical signals from the microphone to the device is via electrical signal conductor and an audio plug.

Further, in a preferred embodiment of the present invention, the microphone and the acoustic energy transformer are positioned in acoustically insulated proximity in a casing.

Additionally, in accordance with a preferred embodiment of the present invention, the microphone and acoustic energy transformer are acoustically insulated and separated in a casing. The insulation means is disposed within the casing and consists of at least one insulating layer, the insulating layer chosen from acoustic barrier elements and acoustically insulating paste.

In yet another preferred embodiment of the present invention, the microphone and the acoustic energy transformer are in separate casings.

Further, in a preferred embodiment of the present invention, the collector portion is positioned inside the portable communication device and in communication with an internal speaker inside the device.

Additionally, there is provided in accordance with the present invention a coupler for an earphone used with a portable communication device. The coupler contains a microphone and an acoustic energy transformer proximately positioned inside one or more casings and acoustically insulated from each other. The acoustic energy transformer converts the electrical output of the device to acoustic waves collected by a collector portion of the earphone, the earphone providing sound waves to the ear of the user.

Further, in accordance with the present invention, the acoustic insulation in the coupler includes one or more acoustic barrier elements or one or more layers of acoustic insulation paste.

In an alternative embodiment of the coupler, the one or more casings is two casings, one casing containing the microphone and one casing the acoustic energy transformer, the casings in acoustic isolation from each other.

Additionally, in accordance with a preferred embodiment the acoustic energy transformer of the coupler is proximately positioned with respect to a hollow element. The element defines an acoustic collecting space where sound-waves emitted from the acoustic energy transformer are collected and passed on to an acoustic tube.

Additionally, in accordance with a preferred embodiment of the present invention, the hollow element is an integrally formed part of the coupler casing.

There is further provided in accordance with the present invention a method for delivering a transmission from a portable communication device to a user with reduced electromagnetic radiation exposure to the user. The method includes the following steps: converting electromagnetic signals into acoustic waves by the portable communication device and then collecting the acoustic waves. This is followed by conveying the collected acoustic waves to the ear of the user through a hollow tube capable of conveying the acoustic waves.

Further, in accordance with an embodiment of the present invention, the converting step of the method is effected inside the portable communication device. In another embodiment of the present invention, the converting step is effected outside the portable communication device.

Additionally, in a preferred embodiment of the present invention, the method further includes the step of transmitting received electromagnetic signals over a wire from the portable communication device to a coupler, the converting step being effected within the coupler.

### BRIEF DESCRIPTION OF THE DRAWINGS

The present invention will be understood and appreciated more fully from the following detailed description taken in conjunction with the drawings in which:

FIG. 1 is a schematic representation of an earphone for a cellular phone, showing front and side views, in accordance with an embodiment of the present invention;

FIG. 2A is a schematic representation of an earphone for a cellular phone, in accordance with a preferred embodiment of the present invention;

FIG. 2B is a schematic representation of an earphone for a cellular phone, in accordance with a variation of the preferred embodiment of the present invention shown in FIG. 2A;

FIG. 3A is an enlarged schematic representation of the coupler used in the embodiment shown in FIG. 2A;

FIG. 3B is an enlarged schematic representation of the microphone and speaker compartments used in the embodiment shown in FIG. 2B;

FIG. 4 is a schematic representation of an earphone for a cellular phone, in accordance with another embodiment of the present invention;

FIG. 5 is a schematic representation of an earphone for a cellular phone, in accordance with yet another embodiment of the present invention; and

FIG. 6 is a schematic representation of an earphone for a cellular phone, in accordance with another embodiment of the present invention.

Similar elements in the above Figures are numbered with similar reference numerals.

### DETAILED DESCRIPTION OF PREFERRED EMBODIMENTS

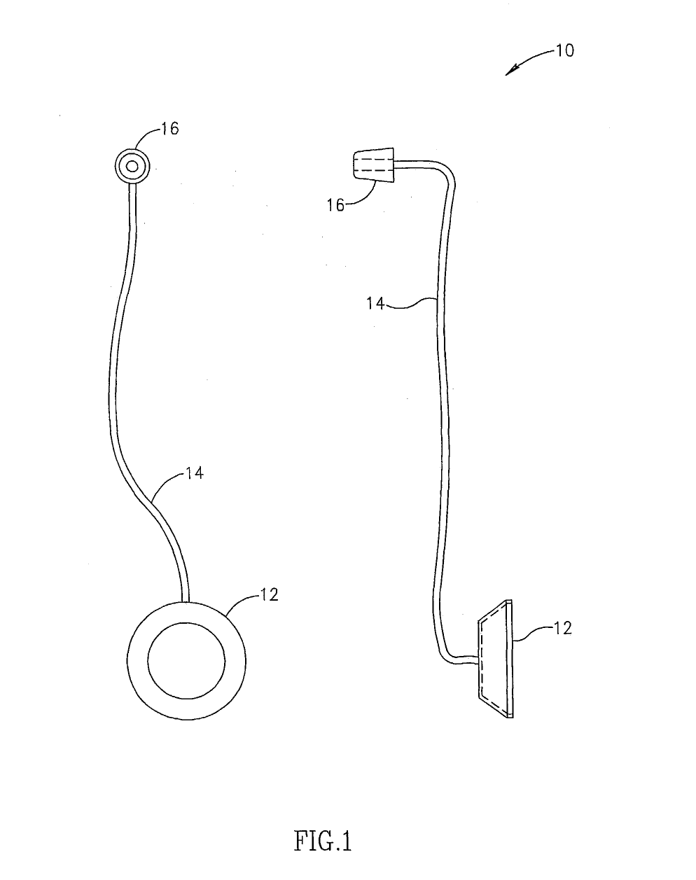

FIG. 1, to which reference is now made, shows a schematic representation of an earphone according to an embodiment of the present invention. Earphone 10 includes a flexible acoustic tube 14 which is fitted with an ear mounting portion 16 at one end and with an acoustic collector head 12 at the other. Acoustic collector head 12 is positioned near, or attached to, the ear piece or speaker of a PCD, for example a cellular phone, where it collects the acoustic signals transmitted by the PCD (cellular phone). These signals are acoustically transmitted through flexible acoustic tube 14 to ear mounting portion 16 and into the ear of the user. It should be noted that in addition to supplying acoustic waves directly to the ear, the earphone keeps the ear of the user distant from the speaker of the PCD, which emits electromagnetic radiation.

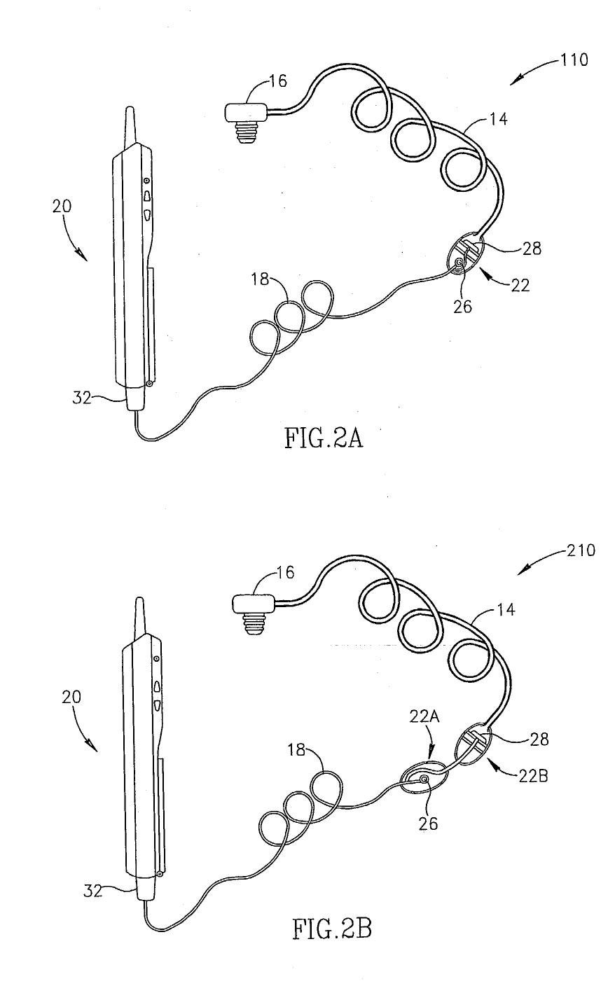

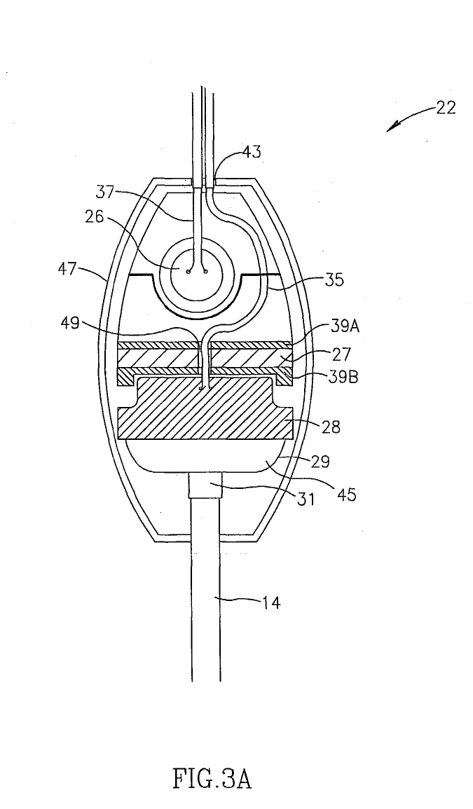

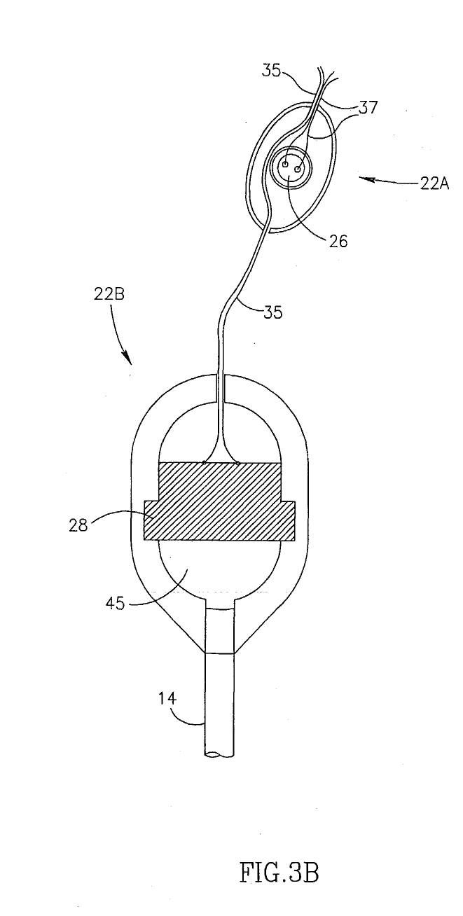

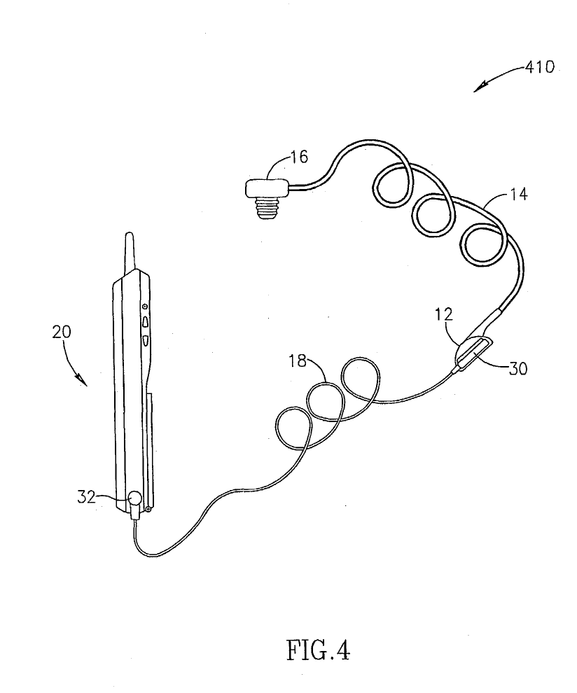

Reference is now made to FIGS. 2A and 2B in which additional embodiments of the present invention are shown. FIG. 2A shows a cellular phone 20 connected by an electric wire 18 to a coupler 22. Electric wire 18 is connected to an audio socket (not shown) of cellular phone 20 by audio plug 32. In coupler 22, a microphone 26 and a speaker 28 are present, separated by at least one piece of acoustic insulation to reduce feedback. Coupler 22 is best seen in, and will be further discussed with reference to FIG. 3A below. Speaker 28 and microphone 26 of coupler 22 are spaced apart and separated with sufficient insulation to prevent interference and feedback between these two elements. A hollow flexible acoustic tube 14 transmits sound waves emitted by speaker 28 to ear mounting portion 16. Acoustic tube 14 has a diameter which optimizes the sound quality being transmitted therethrough.

FIG. 2B is another embodiment of the present invention, very similar to the embodiment shown in FIG. 2A. In FIG. 2B the coupler contains separate acoustically insulated compartments, one for microphone 26 and one for speaker 28 with a wire connecting the compartments. Separating the compartments further reduces feedback between speaker 28 and microphone 26. In the embodiments of both FIGS. 2A and 2B, the input electromagnetic radiation provided by the PCD (cellular phone) has been converted to safer acoustic waves far from the user.

FIG. 3A, to which reference is now made, shows an enlarged top view of the coupler used in the embodiment of FIG. 2A. Coupler 22 contains microphone 26 and speaker 28 separated by acoustic barrier elements 39A and 39B and acoustic insulation paste 27. Speaker 28 transfers the acoustic waves to a generally funnel-shaped hollow element 29 with a nipple-like hollow protuberance 31. Funnel-shaped element 29 defines an acoustic collecting space 45. In some embodiments, element 29 need not be a separate element; instead it may be an integrally formed part of coupler casing 47. While element 29 has been described as funnel-shaped, it is readily evident that element 29 can have any shape provided that it encases a satisfactorily operative acoustic collecting space 45. For example, the shape of element 29 can be square, round, triangular, elliptical, or conical, among others.

Acoustic tube 14 fits into aperture 31 and transmits acoustic waves to an ear mounting portion (not shown). In other embodiments, acoustic tube 14 may be fitted over aperture 31. In yet other embodiments, the sound collected in acoustic collecting space 45 exits through an opening in coupler casing 47. Acoustic tube 14 is inserted directly into and anchored within this opening. In such an embodiment, nipple-like aperture 31 is more properly described as a opening in casing 47.

Wires 37 and 35 which lead to and are plugged into a communications device, typically a cellular phone (not shown), enter coupler 22 at location 43. One set of wires 37 leads to microphone 26 while a second set of wires 35 is led through openings 49 in acoustic barrier elements 39A and 39B to speaker 28. Wires 35 receive an electrical signal from the communication device and deliver them to speaker 28 where they are converted to acoustic signals. Similarly, acoustic signals from the user are received by microphone 26 where they are converted to electrical signals and then delivered by wires 37 to the PCD.

While coupler 22 is shown in the Figures as having an ovoid shape, it is readily understood that the plastic coupler can have any shape. The materials used for the coupler container are typically electromagnetically and acoustically opaque.

Referring now to FIG. 3B, there is shown an arrangement which while generally similar to coupler 22 shown in and discussed with FIG. 3A is different therefrom with regard to the positioning of microphone 26 and speaker 28, which are positioned in separate casings. The independent casings, the microphone and speaker casings 22A and 22B, are essentially similar to that of FIG. 3A but lack acoustic barrier elements 39A and 39B and acoustic insulation paste 27.

Casing 22A contains microphone 26 which collects the acoustic signals emitted by a user and converts them to electrical signals. These signals are then conveyed by wires 37 to a portable communications device (not shown) from which they are transmitted further. Similarly, casing 22B contains speaker 28 which receives electrical signals from a PCD. Speaker 28 converts these signals into acoustic waves which are then collected in acoustic collecting space 45 and passed on to and through acoustic tube 14 to an ear mounting portion 16 (FIGS. 2A and 2B) in the ear of a user.

In FIG. 3B, the acoustic collector portion of the earphone, previously also described as a hollow funnel-shaped element, is integrally formed from a portion of the casing. It surrounds acoustic collecting space 45. In addition acoustic tube 14 can be seen to be inserted directly into an opening in the casing rather than over a nipple of the hollow funnel-shaped element as described above.

Reference is now made to FIG. 4 which shows another embodiment of the present invention. An electric wire 18 is connected to an audio socket (not shown) of device 20, typically a cellular phone, with audio plug 32. At the second end of electric wire 18 is an external speaker 30. In addition, there is an apparatus very similar to that shown in FIG. 1. The apparatus includes a flexible tube 14 to which an ear mounting portion 16 is attached at one end and an acoustic collector head 12 at the other. Collector head 12 and external speaker 30 can be joined by any of a number of methods of attachment, for example by magnets, adhesives, vacuum or mechanical means such as straps, clasps, clamps or Velcro® patches. Similarly, electromagnetic radiation is transmitted to speaker 30 which converts it to sound waves. The latter is collected by acoustic collector head 12 and transmitted to an ear mounting portion 16 via acoustic tube 14.

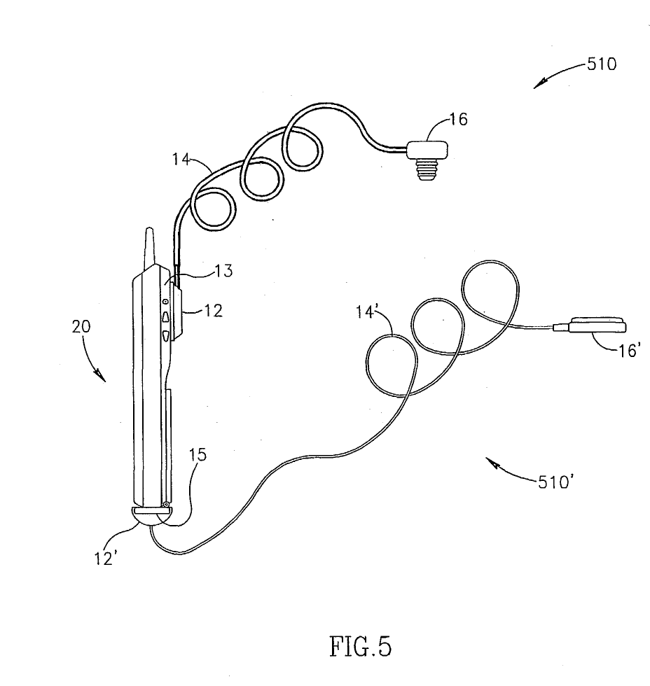

Two additional embodiments of the present invention are shown in FIG. 5 to which reference is now made. In the upper embodiment 510, an acoustic tube 14 to which an ear mounting portion 16 and an acoustic collector head 12 are attached is connected via collector head 12 to an internal speaker 13 of a portable communications device. In the lower embodiment 510′, an acoustic tube 14′ having an acoustic collector head 12′ and ear mounting portion 16′ is attached by its collector head 12′ to an external speaker 15 of a portable communications device 20. It should be evident to one skilled in the art that connection in both embodiments shown in FIG. 5 can be effected by any of a number of methods including, but not limited to, mechanical means such as clamps, clasps, Velcro® patches or straps, magnets, adhesives and vacuum means. Similarly, while we have discussed the embodiments of FIG. 5 as being alternatives, they can be used simultaneously on a single PCD.

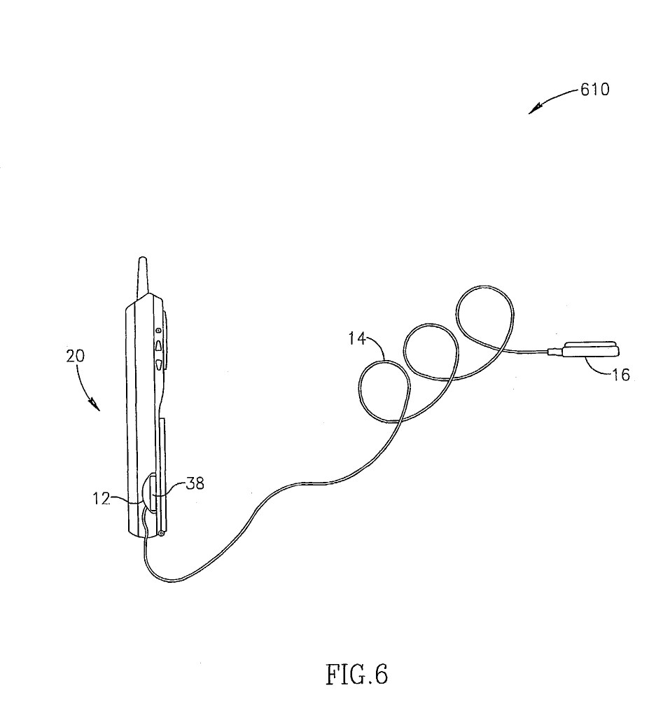

In FIG. 6 to which reference is now made, yet another embodiment of the present embodiment is shown. An acoustic tube 14 having an ear mounting portion 16 and an acoustic collector head 12 is connected to an internal speaker 38 of the portable communication device 20, typically a cellular phone. Unlike the connections in FIG. 5, the connections in FIG. 6 between acoustic collector head 12 and internal speaker 38 is effected inside device 20. Internal speaker 38 is joined to collector head 12 by any number of ways including mechanical means such as clamps, clasps, Velcro® patches or straps, magnets, adhesives and vacuum means.

While all the Figures have shown embodiments with single ear mounting portions, it is readily evident to one skilled in the art that acoustic tube 14 can be constructed as a bifurcated acoustic tube having two ear mounting portions very similar to bifurcated earphones used with Walkmans® and other such portable devices. It should be remembered however that bifurcated earphones used with Walkmans® convey electrical signals, while the bifurcated earphones according to the present invention convey acoustic signals.

The ear mounting portions discussed above can be formed in any number of ways, the ones listed immediately below being most typical. The ear mounting portion can have a cone-like acoustic collecting element gathering acoustic waves from the acoustic tube. The element can be encased in a cone-like encasement fitting directly into the ear and delivering the acoustic waves directly thereto. Alternatively, the ear mounting portion can be constructed as in conventional electrical headsets.

The hollow acoustic tube can be made from almost any flexible tubing, generally a plastic tubing. The primary consideration is that the diameter of the hollow tube should typically be such that the sound collected can be carried therein without distortion and interference, while being convenient to use. Typically this would require tubing having an internal diameter of about 2 to 5 mm, preferably an internal diameter of about 3 to 4 mm.

In all of the embodiments discussed above, sound waves are transmitted to the ear. These can be generated by speakers in the PCD or by speakers external and independent of the PCD. The generation of sound waves requires the conversion of electromagnetic radiation received by the PCD into sound waves. In all cases contemplated by the present invention, this conversion is effected far from the ear of the user. The sound waves produced are collected by an acoustic collecting device and transmitted via a hollow acoustic tube to an ear mounting portion placed proximate to or in the ear.

It will be appreciated by persons skilled in the art that the present invention is not limited by what has been particularly shown and described herein above. Rather the scope of the invention is defined by the claims that follow:

1. An earphone for use with a portable communication device having apparatus for receiving electrical signal energy corresponding to voice signals, a speaker for providing to a user in response to the electrical signal energy audible acoustic energy corresponding to the voice signals, and an audio socket for accessing the electrical signal energy, the earphone including:
a collector portion arranged for connection to the portable communication device so as to receive therefrom energy corresponding to the voice signals received thereby;
an acoustic energy delivery portion configured for fastening in association with the ear of a user, for delivering acoustic energy corresponding to the voice signals; and
an acoustic tube for receiving an energy output from said collector portion and for providing to said delivery portion acoustic energy for delivery to the ear of the user.

2. An earphone according to claim 1, wherein said collector portion includes an acoustic collector arranged for fastening to the speaker of the portable communications device, said acoustic collector being operative to collect audible acoustic energy from the speaker, and to focus it along said acoustic tube for delivery to the ear of a user via said acoustic energy delivery portion.

3. An earphone according to claim 1, wherein said collector portion includes an audio plug arranged for coupling with the audio socket of the portable communications device,
said earphone also including an acoustic energy transformer; and
an electrical signal conductor for conducting electrical signal energy from said audio plug to said acoustic energy transformer,
wherein said acoustic energy transformer is operative to transform the electrical signal energy into audible acoustic energy, and to focus it along said acoustic tube for delivery to the ear of a user via said acoustic energy delivery portion.

4. An earphone according to claim 3, wherein said audio plug, said signal conductor, and said acoustic energy transformer are formed as a unitary plug element, configured for coupling with the audio socket of the portable communications device.

5. An earphone according to claim 1 wherein the speaker of the device is an external speaker and said collector portion of said earphone is attached thereto.

6. An earphone according to claim 5 wherein said collector portion of the earphone is attached to the speaker by at least one of the following means of attachment:
(i) a mechanical element;
(ii) a magnetic element;
(iii) an adhesive material; and
(iv) a vacuum.

7. An earphone according to claim 1 wherein the speaker of the device is an internal speaker and said collector portion of said earphone is attached thereto.

8. An earphone according to claim 7 wherein said collector portion of said earphone is attached to said speaker by at least one of the following means of attachment:
(i) a mechanical element;
(ii) a magnetic element;
(iii) an adhesive material; and
(iv) a vacuum.

9. An earphone according to claim 1 wherein said acoustic energy delivery portion is configured for insertion into the ear canal or for proximal attachment to the external ear of a user.

10. An earphone according to claim 1, wherein said acoustic tube is a bifurcated acoustic tube having two acoustic energy delivery portions for providing acoustic waves to both ears of a user simultaneously.

11. An earphone according to claim 1, and also including an additional speaker for attaching to said collector portion of said earphone.

12. An earphone according to claim 3 further comprising:
a microphone, said microphone receiving acoustic signals from a user, converting them to electrical signals and delivering said electric signals to the device via an electrical signal conductor connected to said audio plug.

13. An earphone according to claim 12 and also including a casing wherein said microphone and said acoustic energy transformer are positioned in acoustically insulated proximity.

14. An earphone according to claim 13 and also including acoustic insulation means disposed within said casing wherein said acoustic energy transformer and said microphone are separated and acoustically insulated by at least one insulating layer of said insulating means, said insulating layer chosen from acoustic barrier elements and acoustically insulating paste.

15. An earphone according to claim 12 and also including separate casings for said microphone and said acoustic energy transformer.

16. An earphone according to claim 1 wherein said collector portion is positioned inside the portable communication device and in communication with an internal speaker therein.

17. A coupler for an earphone used with a portable communication device, said coupler containing a microphone and an acoustic energy transformer proximately positioned inside at least one casing and acoustically insulated from each other, said acoustic energy transformer converting the electrical output of the device to acoustic waves collected by a collector portion of the earphone, said earphone providing the acoustic waves to the ear of a user.

18. A coupler for an earphone according to claim 17 where the acoustic insulation comprises at least one of the following:
(i) at least one acoustic barrier element; and
(ii) at least one layer of acoustic insulation paste.

19. A coupler for an earphone according to claim 17, said at least one casing is two casings, one casing containing said microphone and one casing said acoustic energy transformer, said casings in acoustic isolation from each other.

20. A coupler for an earphone according to claim 17, wherein the acoustic energy transformer is proximately positioned with respect to a hollow element, the element defining an acoustic collecting space where sound waves emitted from said acoustic energy transformer are collected and passed on to an acoustic tube.

21. A coupler according to claim 20 wherein said hollow element is an integrally formed part of the coupler casing.

22. A method for delivering a transmission from a portable communication device to a user with reduced electromagnetic radiation exposure to the user, the method including the following steps:
converting electromagnetic signals into acoustic waves by the portable communication device;
collecting the acoustic waves; and
conveying the collected acoustic waves to the ear of the user through a hollow tube capable of conveying the acoustic waves.

23. A method as in claim 22 wherein the converting step is effected inside the portable communication device.

24. A method as in claim 22 wherein the converting step is effected outside to the portable communication device.

25. A method as in claim 22 further comprising the step of:
transmitting received electromagnetic signals over a wire from the portable communication device to a coupler,
the converting step being effected within said coupler.
